(19) United States
(12) Patent Application Publication
(10) Pub. No.: US 2024/0394798 A1
(43) Pub. Date: Nov. 28, 2024

(54) GOAL AND PERSONAL PLANNING MANAGEMENT APPLICATION

(71) Applicant: POCKETNEST INC., ANN ARBOR, MI (US)

(72) Inventor: Jessica Marie Willis, Huntington Woods, MI (US)

(21) Appl. No.: 18/796,675

(22) Filed: Aug. 7, 2024

Related U.S. Application Data
(63) Continuation of application No. 16/864,599, filed on May 1, 2020, now abandoned.
(60) Provisional application No. 62/842,256, filed on May 2, 2019.

(51) Int. Cl. G06Q 40/06; G06Q 10/0631; G06Q 40/02

(52) U.S. Cl. CPC G06Q 40/06; G06Q 10/06311; G06Q 40/02

(57) ABSTRACT

A goal management system, may include a memory configured to maintain a database of user inputted goal data, the goal data being acquired from users of a goal planning application, the goal planning application configured to provide inquiries to be responded to by the users in furtherance of goals of the users, and a controller configured to receive the user inputted goal data, present at least one admin screen including a plurality of selectable attributes and at least one user in a list of users associated with the user inputted goal data, receive selection of the at least one of the attributes, and update the list of users based on the selected at least one attribute to include users identified as requiring the at least one service provided by the third party service provider.

### CROSS-REFERENCE TO RELATED APPLICATIONS

This application is a continuation of U.S. application Ser. No. 16/864,599 filed May 1, 2020, which, in turn, claims the benefit of U.S. provisional application Ser. No. 62/842,256 filed May 2, 2019, the disclosures of which are hereby incorporated in their entirety by reference herein.

### TECHNICAL FIELD

Disclosed herein is a goal and personal planning management application.

### BACKGROUND

Various institutions, such as banks, lenders, insurance providers, and other service providers for personal growth and management may acquire and filter data on certain individuals in order to gain knowledge about that individual. This knowledge may then be used to provide the individual with certain products, or features. However, often times this data is difficult to acquire due to the data being stored and acquired across multiple platforms. Furthermore, individual users are less reluctant to fill out lengthy forms and provide cumbersome and overly extensive information.

### SUMMARY

A goal management system, may include a memory configured to maintain a database of user inputted goal data, the goal data being acquired from users of a goal planning application, the goal planning application configured to provide inquiries to be responded to by the users in furtherance of goals of the users, and a controller configured to receive the user inputted goal data, present at least one admin screen including a plurality of selectable attributes and at least one user in a list of users associated with the user inputted goal data, wherein at least one of the selectable attributes is associated with at least a portion of the user inputted goal data and corresponds to at least one service provided by a third party service provider, receive selection of the at least one of the attributes, and update the list of users based on the selected at least one attribute to include users identified as requiring the at least one service provided by the third party service provider.

A goal management system may include a memory configured to maintain a database of user inputted goal data, and a controller configured to present a series of screens via a user interface to a user, wherein at least one of the screens presents an inquiry to the user associated with a specific goal, wherein the series of screens present inquiries associated with specific goal, receive at least one user input in response to the inquiries, determine whether each of the inquiries being completed, and in response to each of the inquiries being completed, present a goal completed screen indicating that a goal has been achieved.

A method for a goal management system may include presenting a series of screens via a user interface to a user, wherein at least one of the screens presents an inquiry to the user associated with a specific goal, wherein the series of screens include inquiries associated with the specific goal, receiving at least one user input in response to the inquiries, determining whether each of the inquiries has been completed, and in response to each of the inquiries being completed, presenting a goal completed screen indicating that a goal has been achieved.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings:

FIG. 1 illustrates an example goal management system;

FIG. 2 illustrates an example flow chart for a series of badge related screens for a goal application of FIG. 1;

FIGS. 3A-J illustrate various snapshot related screens where

FIG. 3A illustrates an example welcome screen,

FIG. 3B illustrates an example badge screen,

FIG. 3C illustrates an example completion screen,

FIG. 3D illustrates an example home screen,

FIG. 3E illustrates an example summary screen,

FIG. 3F illustrates another example summary screen,

FIG. 3G illustrates an example to-do list screen,

FIG. 3H illustrates an example home setup screen,

FIG. 3I illustrates an example vehicle setup screen, and

FIG. 3J illustrates a dependent setup screen;

FIGS. 4A-4D illustrate various budget related screens where

FIG. 4A illustrates an example income screen,

FIG. 4B illustrates an example budget for wants screen,

FIG. 4C illustrates an investment budget screen, and

FIG. 4D illustrates an example budget summary screen;

FIGS. 5A-D illustrate various debt related screens where

FIG. 5A illustrates an example debt screen,

FIG. 5B illustrates an example selectable debt screen,

FIG. 5C illustrates another selectable debt screen, and

FIG. 5D illustrates a net worth debt screen;

FIGS. 6A-E illustrate insurance related screens where

FIG. 6A illustrates an example life insurance screen,

FIG. 6B illustrates an example insurance calculator screen,

FIG. 6C illustrates an example property insurance screen,

FIG. 6D illustrates a long term coverage screen, and

FIG. 6E illustrates a general bid screen;

FIGS. 7A-7C illustrate various of retirement related screens where

FIG. 7A illustrates an example 401k screen,

FIG. 7B illustrates an example retirement calculator screen, and

FIG. 7C illustrates another example retirement calculator screen;

FIGS. 8A-8E illustrate various investment related screens where

FIG. 8A illustrates an example investment welcome screen,

FIG. 8B illustrates an example risk tolerance screen,

FIG. 8C illustrates an example risk level screen,

FIG. 8D illustrates an example investment allocation screen, and

FIG. 8E illustrates an example investment badge completed screen;

FIGS. 9A-9E illustrates various tax related screens where

FIG. 9A illustrates an example income tax screen,

FIG. 9B illustrates an investment tax screen,

FIG. 9C illustrates a gift tax screen,

FIG. 9D illustrates an income tax bracket screen, and

FIG. 9E illustrates an example tax badge completed screen;

FIGS. 10A-10D illustrate various estate planning related screens where

FIG. 10A illustrates an example estate start screen,

FIG. 10B illustrates an example estate inquiry screen,

FIG. 10C illustrates an example recommendation screen, and

FIG. 10D illustrates an example to-do screen;

FIGS. 11A-11C illustrate various education related screens where

FIG. 11A illustrates an example education start screen,

FIG. 11B illustrates an example ‘no kid’ education screen, and

FIG. 11C illustrates a savings calculator screen 1106;

FIGS. 12A-12C illustrate various screens related to an annual review or the overall goal plan review where

FIG. 12A illustrates an example annual credit review screen,

FIG. 12B illustrates an example life change screen, and

FIG. 12C illustrates an example spouse inquiry screen;

FIGS. 13A-D illustrate example user interface screens provided by the service provider application of FIG. 1 where

FIG. 13A illustrates an example admin interface,

FIG. 13B illustrates the example admin user interface with a filter panel,

FIG. 13C illustrates an example user profile interface, and

FIG. 13D illustrates and example user report;

FIG. 14 illustrates an example process for the service provider application of FIG. 1; and

FIG. 15 illustrates an example process for the goal application of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is an application directed to meeting and maintaining goals based on a holistic approach to financial planning. The application may, based on a user's needs and wants, connect the user with third party service providers such as financial institutions. These institutions may be customers of the overall application and may subscribe to a third party application facilitated by data provided by the individual application The application may, via a user interface, allow the user to define his or her retirement goals, provide to-do lists as part of a financial and equitable check-up, and overall guide the user through a financial planning model specific to the user based on user inputs. Various visual interfaces, including badges, progress bars, dynamic to-do lists, etc., may be used to encourage certain activities by the user, as well as the third party service providers. The application may include a web-based or app-based interface that may include a goal aggregator. The goal aggregator may, based upon a user's inputs, connect the user with the third party service providers.

The third party service providers may be presented with a user interface that collates the user entered data into a succinct, customizable, and filterable system. The third parties may receive the necessary user provided data, in order to group, filter, and identify users, by certain user characteristics. For example, a certain group of users, based on customized filters from the third party, may be identified as needing life insurance products. This determinization may not have been possible without the user input and centralized systems described herein. Without the centralized and use friendly system, the data necessary to make such product determination may not be available, may not be easily accessible, may be stored and located across several platform and various physical files and locations, and may further require undue time and effort to obtain. By guiding a user through an easy to use, easy to navigate, and encouraging processes via the goal application, the necessary user profile and data information may be easily obtained by the third party providers in order to aid the individual in obtaining his or her goals. Linked accounts, such as a user's bank account, may also be considered by the third party service providers for filtering information. Linked accounts may also include users' student loans, mortgages, credit card accounts, including balances, insurance account, college savings accounts, investment accounts, etc.

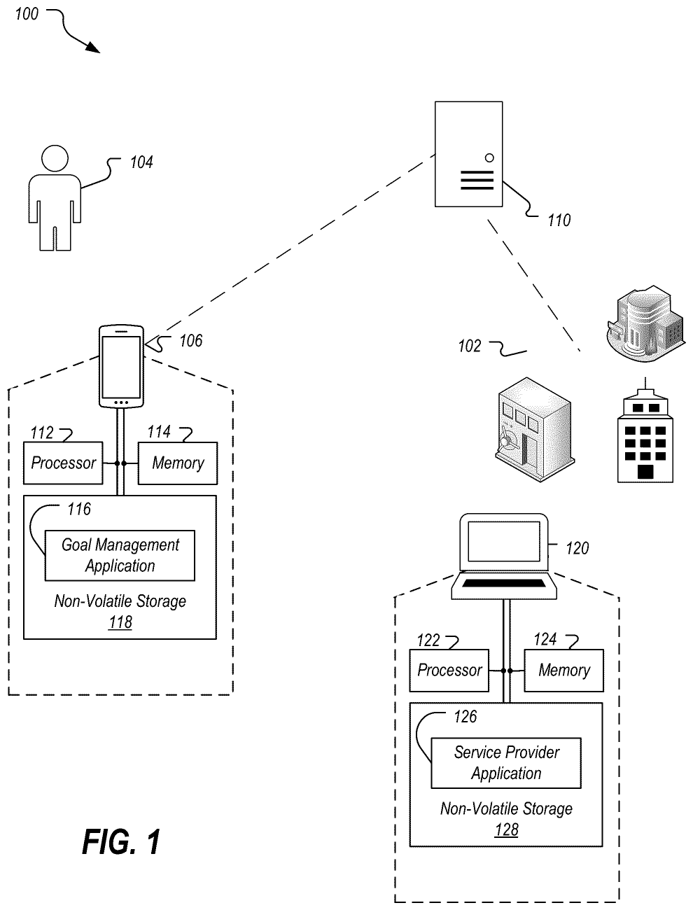

FIG. 1 illustrates an example goal management system 100 for evaluating and addressing various user goals, such as life and financial goals, through sophisticated planning. The system 100 provides an organized checklist for reaching personal and financial goals.

The system 100 may include a user device 106. In the example shown in FIG. 1, the user device 106 is illustrated as being a mobile device 106. However, the mobile device 106 may be any form of computing device capable of receiving user input such a smart phone, tablet computer, personal digital assistant, smartwatch, MP3 device, laptop computer, etc. The mobile device 106 may include a processor 112 including a controller, and a memory 114. The controller may be generally coupled to memory 114 via the processor 112 for operation of instructions to execute equations and methods described herein. In general, the controller is programmed to execute the various methods as noted herein. For example, the controller may generate a sequence screens to iteratively guide the user 104 through the goal process described herein.

The user 104 may be an individual interested in personal goal setting. The user 104 may also be a couple, a partner, a family, or other groupings of persons that share their lives together.

The mobile device 106 may include non-volatile storage 118 maintaining a goal management application 116. The mobile device 106 may also include a display configured to display various screens to the user 104. The goal application 116 may be configured to be executed by the controller of the mobile device 106. The goal application 116 is described in more detail below with respect to the screens illustrates in the figures.

The server 110 may be a remote computing device configured to store and maintain data, as well as act as a gateway to other mobile devices (not shown) operated by other users. The server 110 may include a goal aggregation server configured to aggregate goals based on the user input at the mobile device 106. The server 110 may maintain a database of user inputted data received from the goal application 116.

The goal application 116 may be configured to receive input from the user 104 regarding the various goals and information about the user 104. For example, the user input may include the current income of the user. The user input may include other financial and life-style information about the user, such as the user's debt, retirement and investment account information, etc. Such information provided by way of the user inputs is described in more detail below with respect to the screen shots and flow charts disclosed herein.

The system 100 may include at least one third party service provider 102. As explained above, the third party service provider 102 may include institutions that provide a service to users, the service providers 102 including but not limited to, financial and banking institutions, retirement service companies, insurance companies, universities, employers, etc. The third party service provider 102 may be associated with a computing device 120, such as a smart phone, tablet computer, personal digital assistant, smartwatch, MP3 device, laptop computer, etc. The computing device 120, similar to the user device 106 associated with the user 104, may include a processor 122 including a controller, and a memory 124. The controller may be generally coupled to memory 124 via the processor 122 for operation of instructions to execute equations and methods described herein. In general, the controller is programmed to execute the various methods as noted herein. For example, the controller may generate a user interface screen configured to provide the service provider 102 with customizable information about certain users.

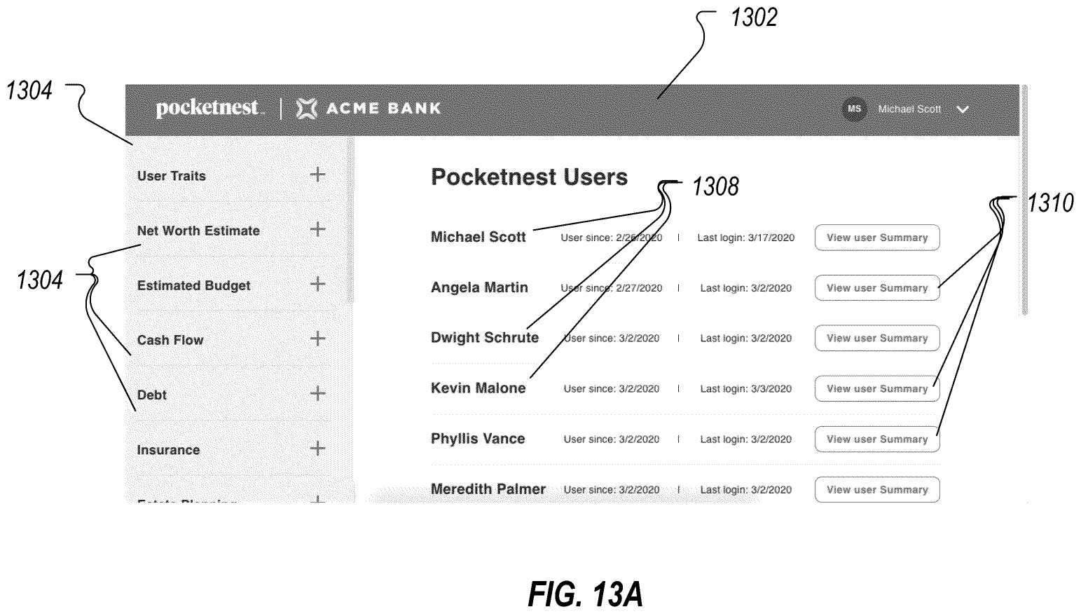

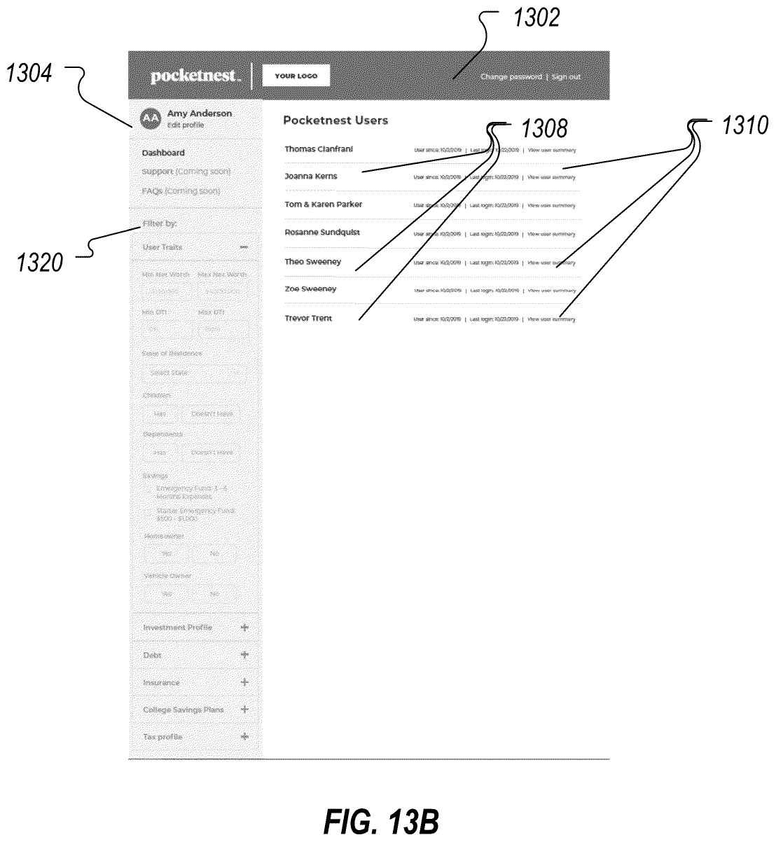

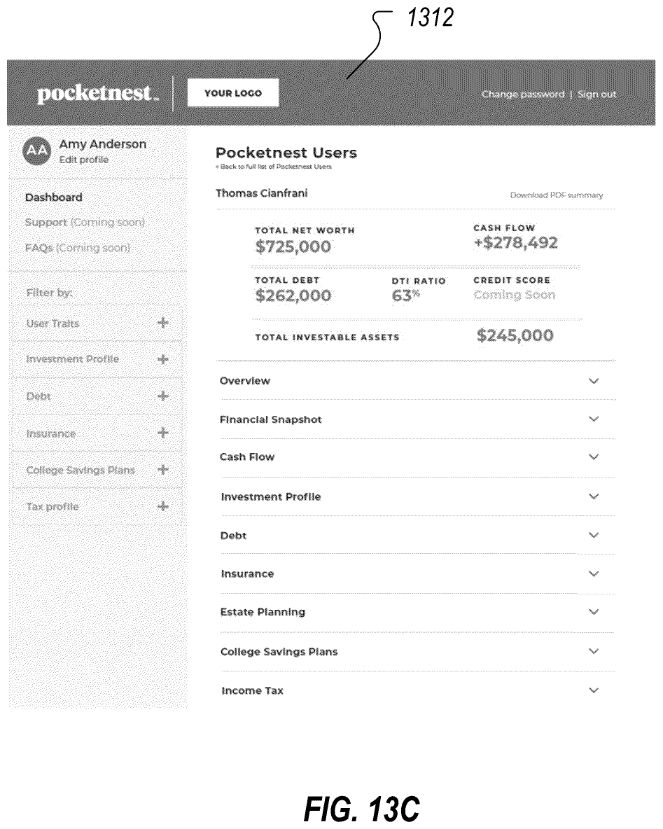

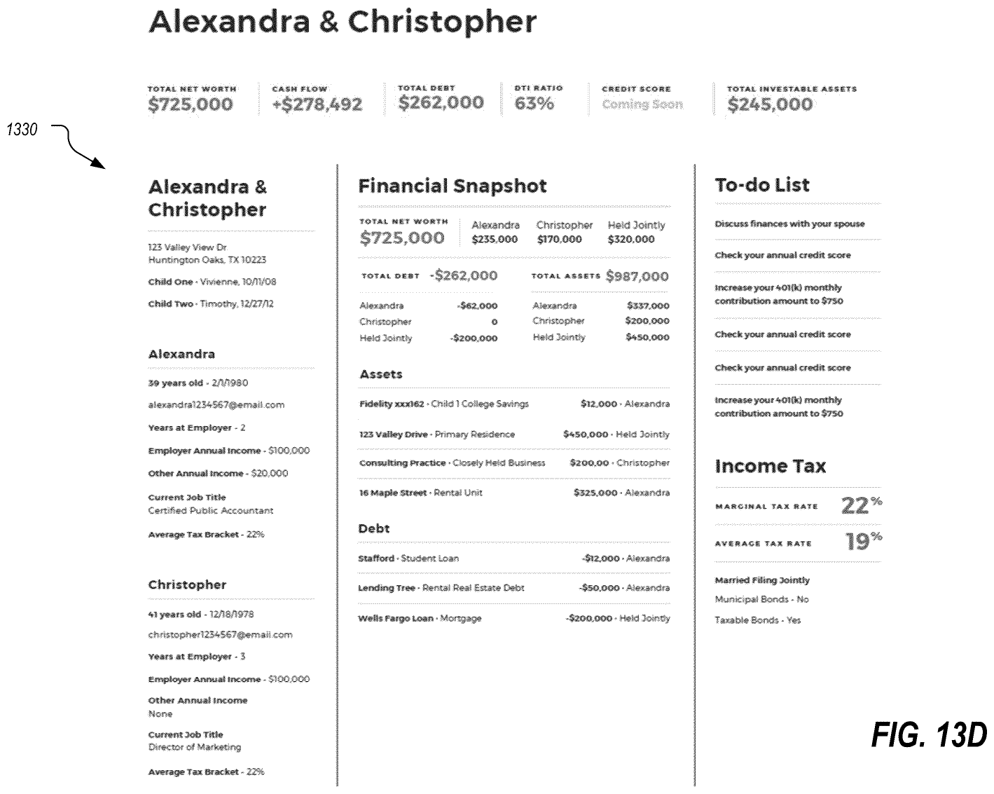

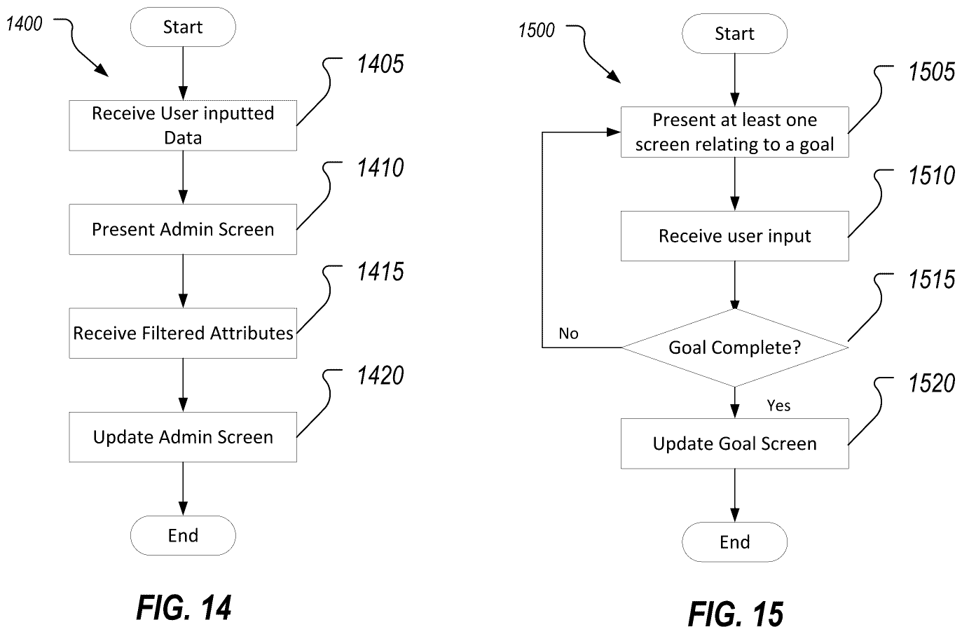

The computing device 120 may include non-volatile storage 128 and a service provider application 126. The device 120 may include a display configured to display various screens to an individual of the service provider 102. The service provider application 126 is described in more detail below with respect to the screens illustrates in the figures, for example, sec FIGS. 13 and 14.

The service provider application 126 may be used to collect and analyze the user's data, and provide the data to one or both of the user and/or third party service providers 102, as well as to connect and analyze user's accounts. This aggregation may be done at the server 110, as well as at the mobile device 106, in addition or in alternative to the computing device 120. The service provider application 126 may provide user specific data such as network, personal loan debt, insurance coverage, etc. The service provider application 126 may also provide aggregate data on a group of users, or aid in filtering out users with specific goal needs to help the user achieve the goals set out in the goal application 116.

The user device 106, server 110, and computing device 120, as well as other devices may communicate with each other over a network, either wired or wireless. For example, the network may be a local area network (LAN), a wide area network (WAN), the Internet, an extranet, a cellular network, or another wireless network configured to transmit data between the devices and entities. Further, while only a single user device 106 and computing device 120 are illustrated, more than one of these devices are likely to be used in the system 100.

The service provider application 126 may also receive information from linked accounts such as the user's bank account and derive user data from this account. For example, the service provider application 126 may be able to determine cash flow of the user 106, whether the user's credits exceed his or debits, whether certain bills are paid on time, whether a minimum balance is maintained. Even further, the application 126 may determine whether the user is saving a predefined percentage, accruing any unnecessary fees, etc.

The linked accounts may be made available by the third party service provider, through PLAID or a similar institution, or through the user 104. This user data provided by the linked accounts may include various pieces of data that correspond, supplement and validate information provided by the user 104 at the goal management application. Internal processes and systems described herein and provided by the application 126 may allow for a one stop shop for the third party service providers 102 to recognize needs and wants of users 104 without undue investigations, tedious data review, etc.

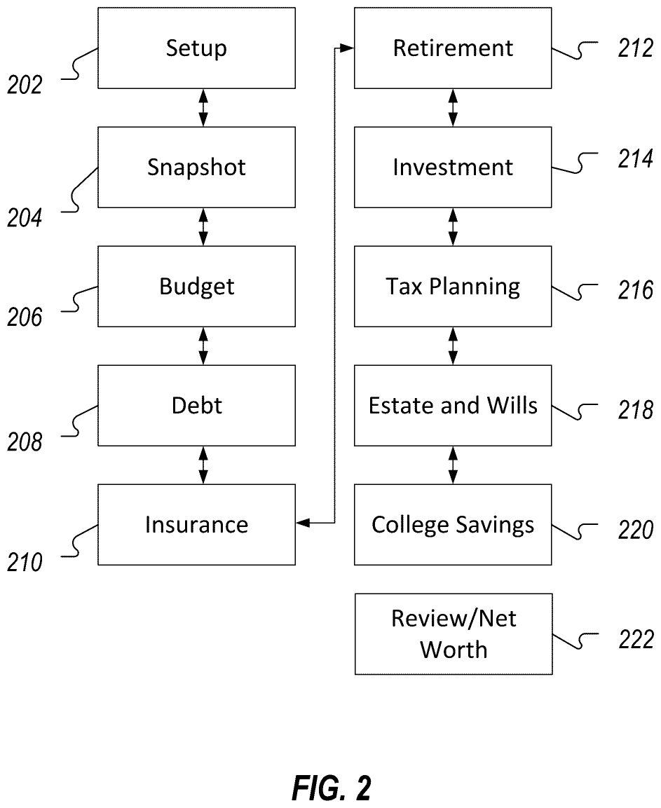

FIG. 2 illustrates an example flow chart for a series of badge related screens. Badges may be earned by the user upon completion of performing certain tasks, such as answering questions, updating information, etc. Each badge may have a series of unique screens aimed towards gathering information from the user relevant to that badge. For example, the screens may ask for the user's savings amounts, debt amount, and insurance coverage. In addition to specific questions about current coverage, loans, etc. the goal application 116 may also guide the user by asking other questions, such as “when was the last time you had your insurance coverage re-bid,” or “when was your estate plan last reviewed.” Examples of some of these iterative screens are illustrated and discussed herein. While the screens are described as relating to a certain badge or goal, attributes, data, and inquiries of each screen may also be relevant to other badges and goals.

Each badge relates to a specific goal for the user and may step the user through a series of inquiries relative to that goal. Upon answering the questions, and in response to certain questions, the application 116 may generate “to do” items for the user. These may include follow up items such as “reevaluate your cash reserve”,” “consider rolling over your 529 plan to a better state's plan.” In doing this, the tedious process of goal management is broken down into management segments for the user, allowing more detailed, more accurate, and more complete information to be voluntarily provided.

Example badges may include Setup 202, Snapshot 204, Budget 206, Debt 208, Insurance, 210, Retirement 212, Investment 214, Tax Planning 216, Estate and Wills 218, College savings 220, and Review/Net Worth 222. While an example order and organization are discussed herein with respect to each badge and related screens, other organization, additional badges, etc., may also be included. Further, to aid in user operability, the goals do not need to be completed in one sitting, in a set order, or even at all. The user had the opportunity to pick and choose which badges/goals he or she completes on his or her own time.

Example screens related to each badge are described below.

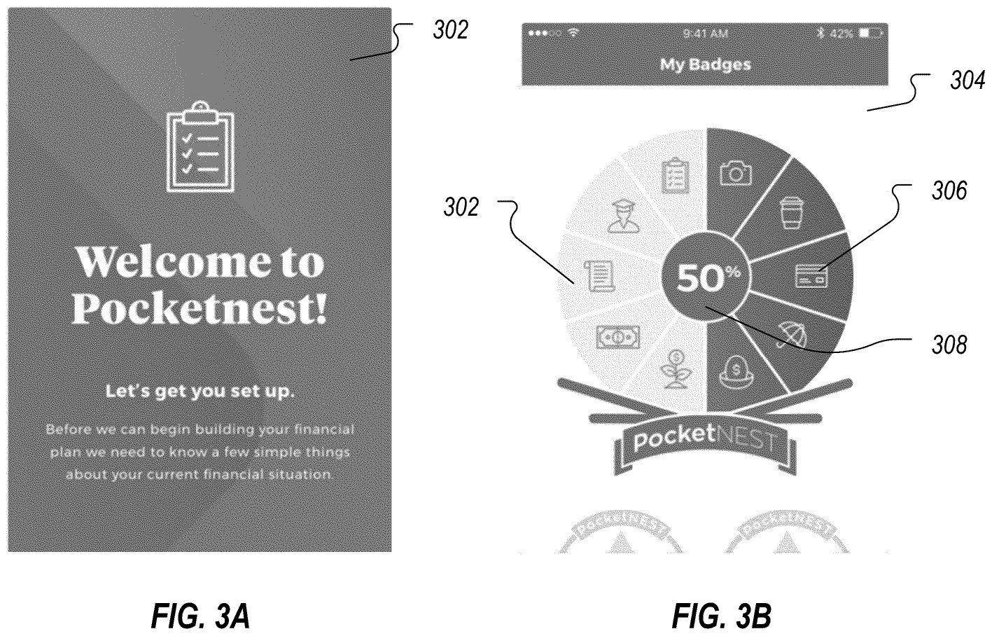

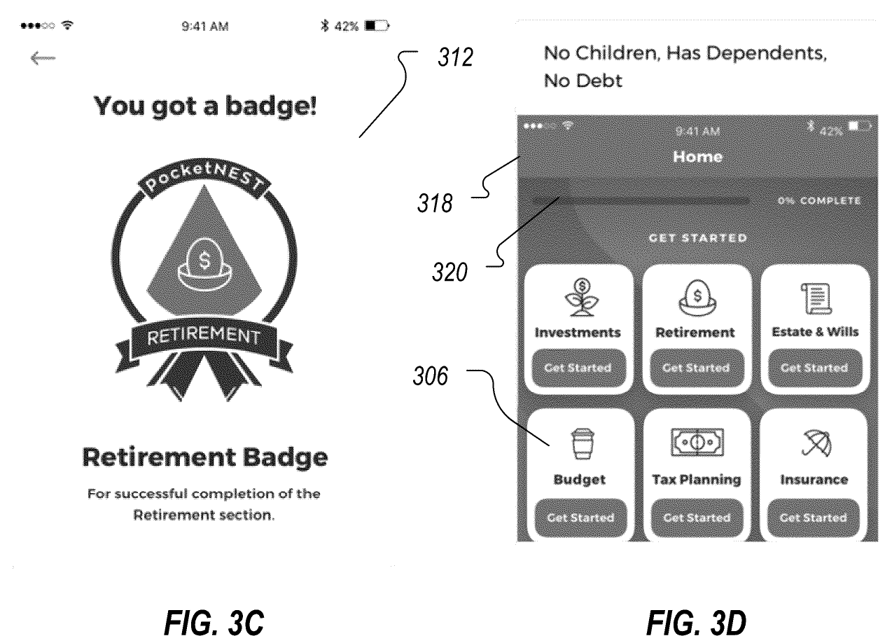

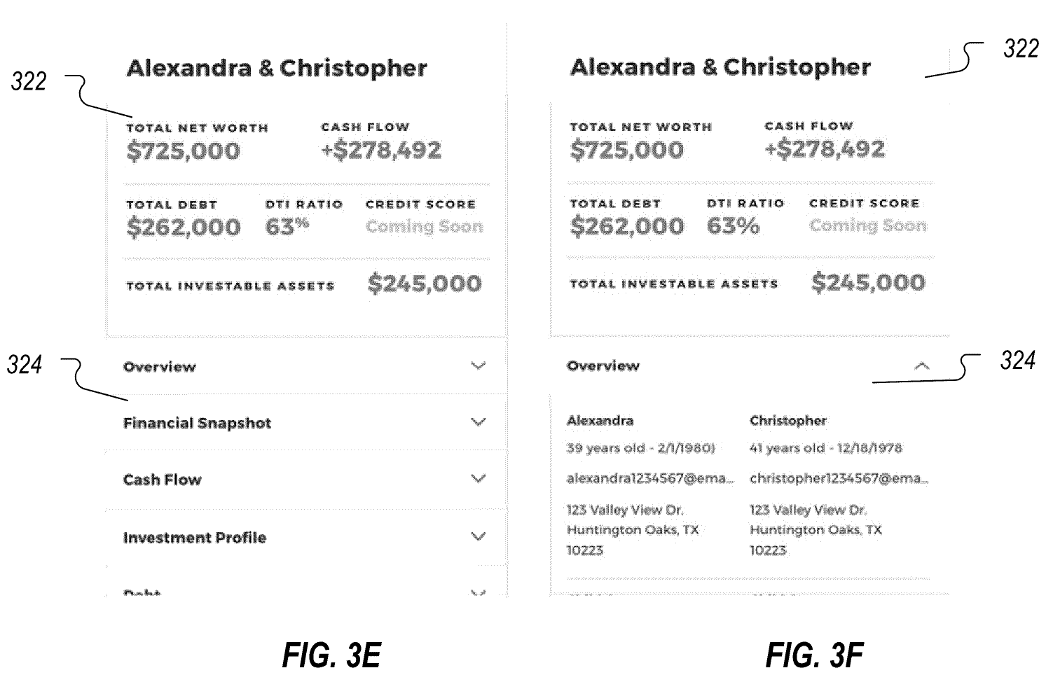

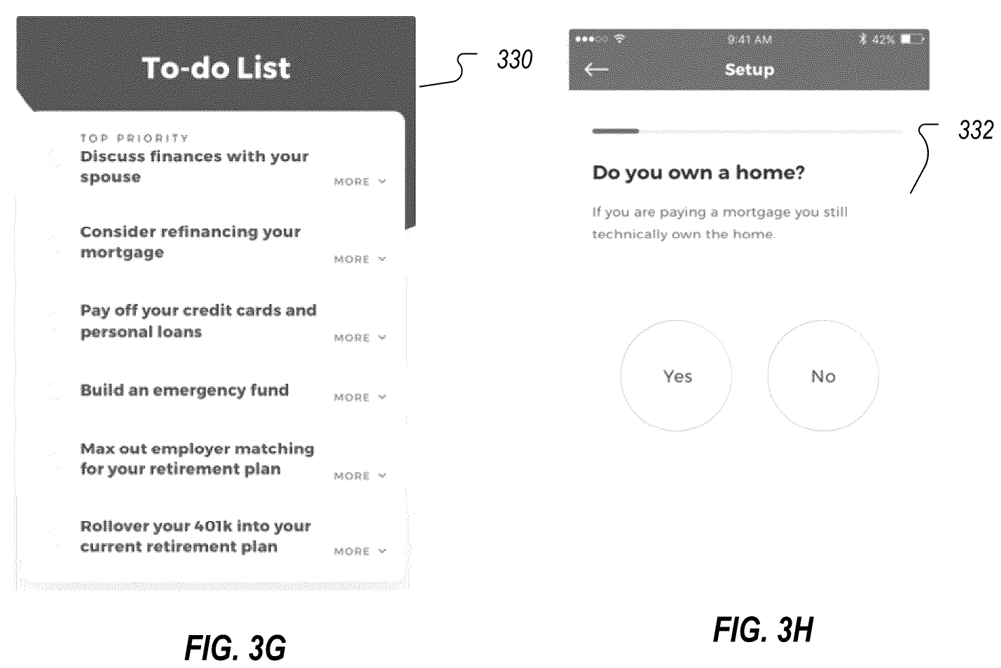

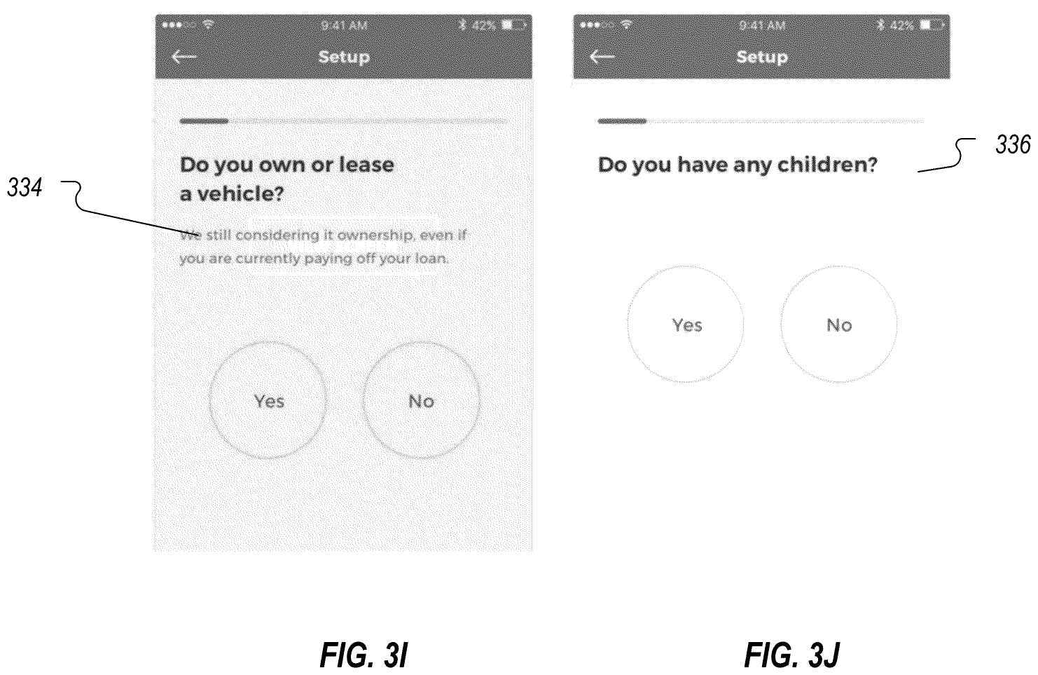

FIGS. 3A-J illustrate various snapshot 204 and setup 202 related screens. These badge related screens provide the user, as well as encourage the user, to make progress with their goal application by providing information and completing various tasks. For example, FIG. 3A illustrates an example welcome screen 302.

FIG. 3B illustrates an example badge screen 304. The badge screen 304 may illustrate a wheel including a plurality of badges 306. Each of the badges 306 may include an icon, as shown, providing an indication as to the type of badge. Additionally or alternately, written indicia may indicate the badge type. A status of completion indicator 308 may be arranged in the center of the wheel of badges 306. This may indicate the percentage, fraction, or number, of badges that the user has completed. Additionally or alternatively, this indicator 308 may indicate an overall completion level of all questions presented via the screens. The badges 306 may change in appearance as each is completed. In one example, the color may change. In another, the badge 306 may be emphasized, by bolding, etc.

FIG. 3C illustrates an example completion screen 312. This completion screen may be presented once a user has made his or her way through a series of screens for that specific badge 306. Such completion screens and completion indications as shown in FIG. 3B, encourage the user to continue to answer questions and provide information.

FIG. 3D illustrates an example home screen 318. This home screen 318 may also provide the user with a snapshot of the information presented, as well as a status bar 320 indicating the progress made so far. In this example screen, the user has not made any progress and is at the initial state of using the goal application 116. The badges 306, similar to FIG. 3B, may alter in appearance as each is completed.

FIG. 3E illustrates an example summary screen 322. This summary screen 322 may present a summary of the information provided by the user. The summary screen 322 may include drop down menus 324 configured to provide additional and detailed information about the user. FIG. 3F illustrates the example summary screen 322 with the ‘overview’ selectable option selected.

FIG. 3G illustrates an example to-do list screen 330. This screen 330 provides a list of items that are to be completed by the user. This to-do list may include items that were not answered in the various screens. For example, the to-do list may include an item such as “please input the interest rate for your mortgage.” Additionally or alternatively, the to-do list may include items in response to specific answers and data provided by the user. For example, if the user responded in the negative to the question “have you discussed finances with your spouse,” then this item may appear on the to-do list. Other to-do items may relate to specific financial or life events.

To-do items may also be pushed to the user device 106 by the server 110 and/or the service provider 102. These items may be in response to a global event, such as a world conflict, pandemic, etc. In another example, these items may be pushed to the user device 106 in response to an event, such as a tax deadline. The pushed to-do item may include “be sure to file your taxes by April 15,” or “have you spoken to your partner about the financial effects of recent events?”

In some of these pushed to-do items, the to-do's may be pushed in response to certain criteria being met. The predefined criteria may relate to the to-do item, such as certain thresholds, facts, etc., as inputted by the user or derivable from linked accounts. For example, the criteria may include a marital or partner status. The to-do relating to speaking to your partner may only be pushed to those users that have indicated, or that the data provided via the linked accounts has indicated, that they are in a partnership or married. Other criteria may exist, such as age, tax bracket, savings, location, etc. The to-do may be pushed by the service provider 102 and may be specific to the service provider's subscribers. In other examples, the to-do may be pushed by the server 110.

In some examples, the service provider 102 may also push specific to-do's to the user 104. These specifically tailored to-dos may relate to an action item specific to a relationship between the user and the service provider, such as “upload proof of insurance,” or “finalize tax forms.”

FIG. 3H illustrates an example home setup screen 332 where the controller presents a screen inquiring as to whether the user owns a home. FIG. 3I illustrates an example vehicle setup screen 334 where the controller presents a screen inquiring as to whether the user owns or leases a vehicle. FIG. 3J illustrates a dependent setup screen 336 inquiring as to whether the user has children.

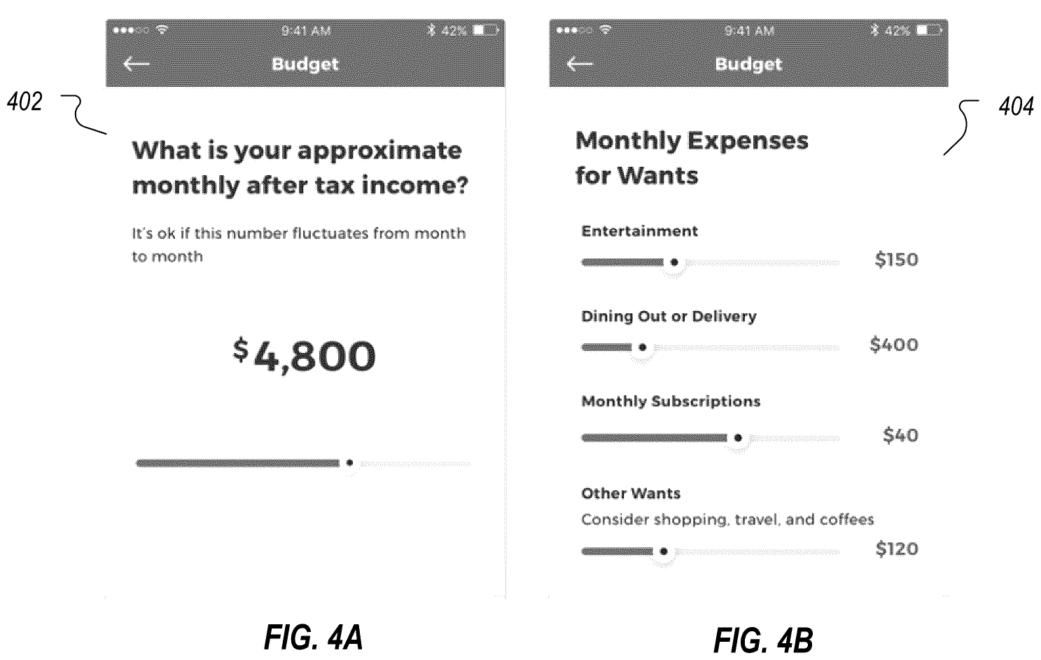

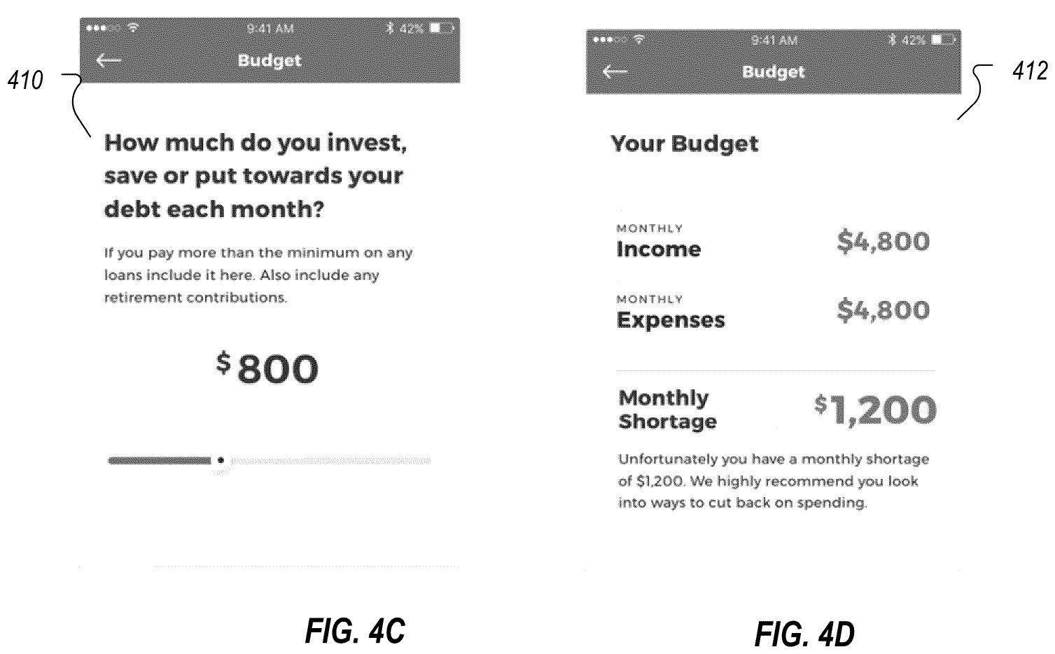

FIGS. 4A-4D illustrate various budget related screens. The budget screens may allow the user to see and enter certain types of budget information, such as monthly and annual budgets, etc. These include example screens related to social sharing of the badge achievements, as well as additional information to promote the goal application, as well as the user's own personal financial responsibility.

FIG. 4A illustrates an example income screen 402. This screen 402 may present an inquiry into what the user's taxable income is. FIG. 4B illustrates an example budget for wants screen 404. Each of these screens may include slidable tracks that allow the user to increase or decrease the amount by sliding the pointer along the track. Additionally or alternatively, a text box may be presented to allow for digital input of a numeric number for the user's income and budget.

FIG. 4C illustrates an investment budget screen 410. In this screen the user may select how much he or she invests each month. FIG. 4D illustrates an example budget summary screen 412 which may indicate monthly income, monthly expenses, and the monthly shortage or surplus.

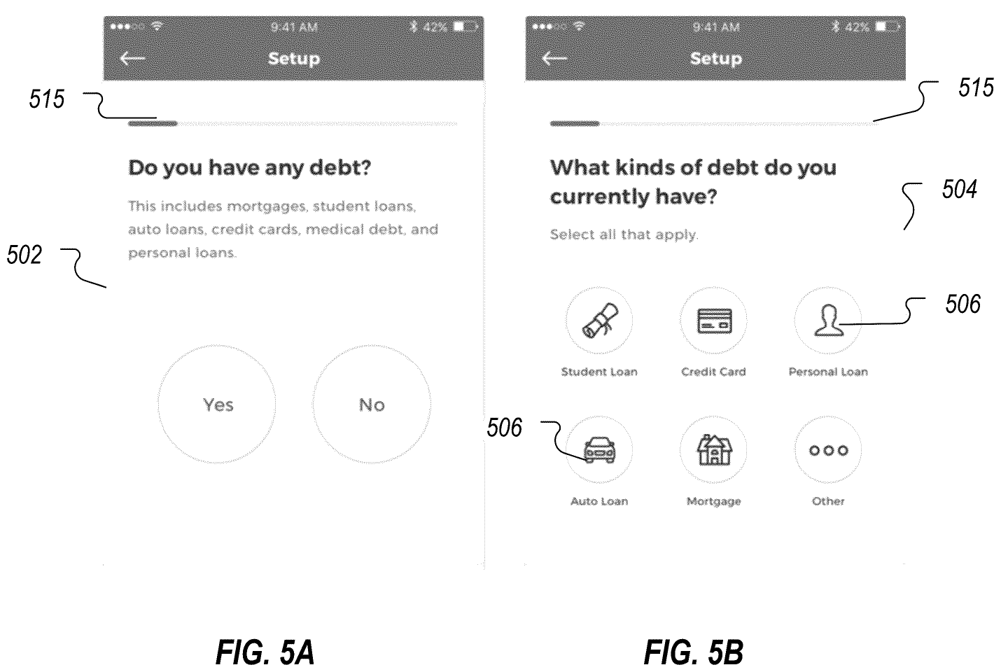

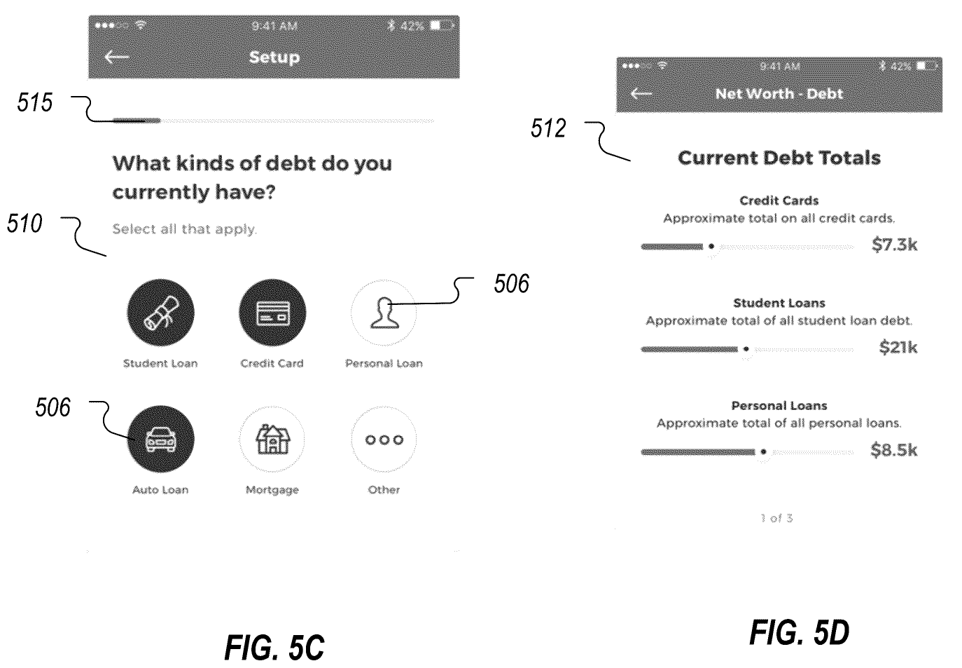

FIGS. 5A-D illustrate various debt-related screens. The debt screens may allow the user to see and enter certain types of debt information, such as credit card dept, house and car loans, student loans, etc. The server 110 or service provider 102 may provide certain recommendations to the user based on the debt information provided. For example, the server 110 may recommend that the user reevaluate the type of mortgage that the user current has and provide the option for the user to connect with a third party lender. These recommendations may be done via the to-do list. For example, the recommendations may be automatically added to the to-do list as additional items to do. As explained above, these recommendations may be pushed by the service provider in response to certain criteria being met. This is described in greater herein.

FIG. 5A illustrates an example debt screen 502 inquiring whether the user has any dept. If the user selects the ‘yes’ button, the goal application 116 may proceed to present the user with additional screens relating to debt. For example, FIG. 5B may present the user with a selectable debt screen 504. This screen 504 may present a plurality of debt icons 506 each representing a type of debt. The user may select one or more icons 506 and enter a debt amount relating to each type of debt.

FIG. 5C illustrates another selectable debt screen with a portion of the debt icons 506 being selected. FIG. 5D illustrates a net worth debt screen 512 summarizing the user's debt. In each of the debt screens, and similar to other badge screens, a progress bar 514 may be presented to indicate a progress level relating to that particular badge.

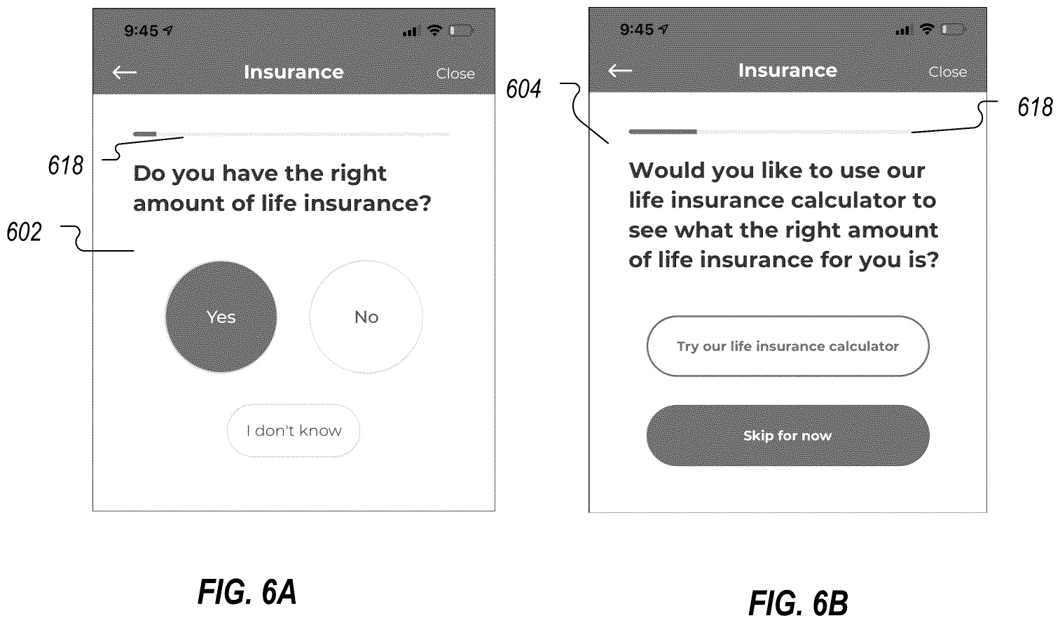

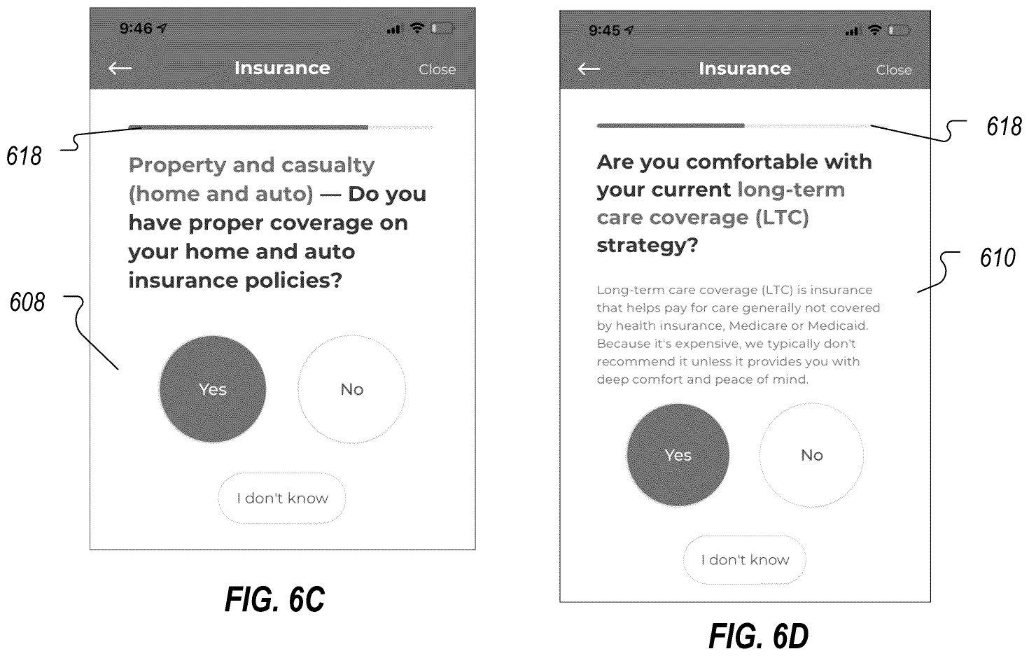

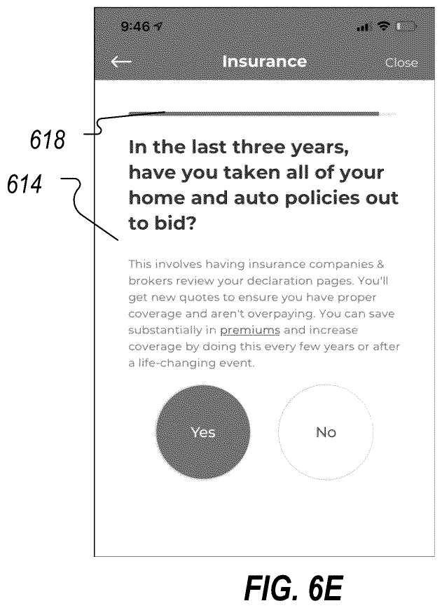

FIGS. 6A-6E illustrate insurance related screens. The insurance screens may allow the user to see and enter insurance information, including long term coverage, disability insurance, auto and homeowner insurance, etc. The server 110 and/or service provider 102 may provide certain recommendations to the user based on the insurance information provided. For example, the server 110 may recommend better disability insurance and provide the option for the user to connect with a third party provider of the same.

FIG. 6A illustrates an example life insurance screen 602, inquiring as to whether the user believes he or she has the right amount of life insurance. If the user selects “No,” the goal application may proceed to present the user with a life insurance calculation option screen 604, as shown in FIG. 6B.

FIG. 6C illustrates an example property insurance screen 608 inquiring into the coverage of home and auto insurance. FIG. 6D illustrates a long-term coverage screen 610 inquiring with respect to the user's long-term insurance. FIG. 6E illustrates a general bid screen 614 inquiring into whether the user has taken various insurance policies to bid in recent history. Each of the insurance screens, similar to the debt screens, may include a progress bar to indicate a progress level relating to insurance badge.

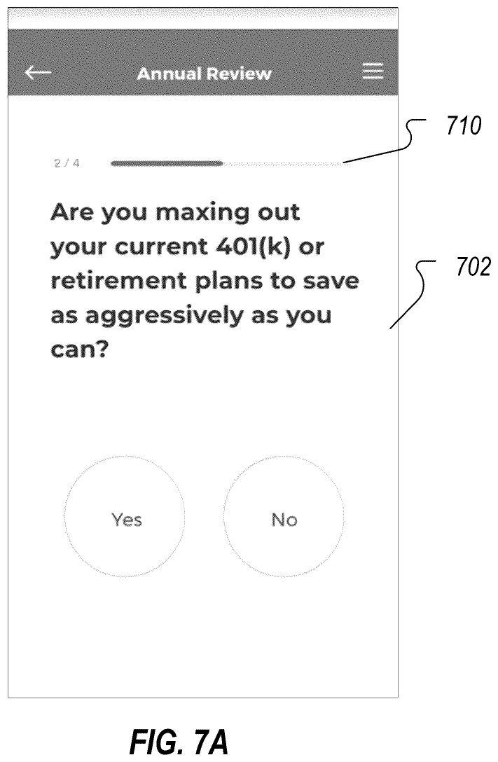

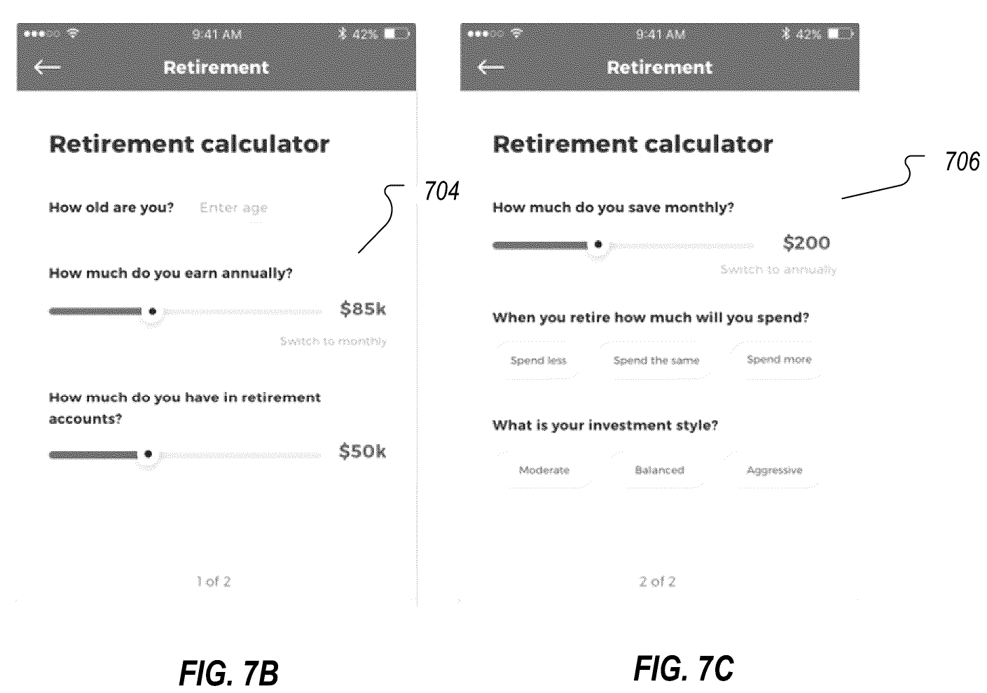

FIGS. 7A-7C illustrate various of retirement related screens. The retirement screens may allow the user to run a retirement plan based on current income, desired retirement amount, etc.

FIG. 7A illustrates an example 401k screen 702 inquiring into the user's use of a 401k plan. This screen 704 may inquire into whether the user is maxing out his or her 401k. FIGS. 7B and 7C illustrate example retirement calculator screens 704, 706. These screens 704, 706 may present the user with questions relating to the calculation of retirement needs, such as how much the user currently earns, how much is in a user's retirement accounts, a spending style, and an investment style. Upon completion of these questions, the user may be presented with an estimated amount that the user will need upon retirement, and how much the user should be saving monthly based on this need.

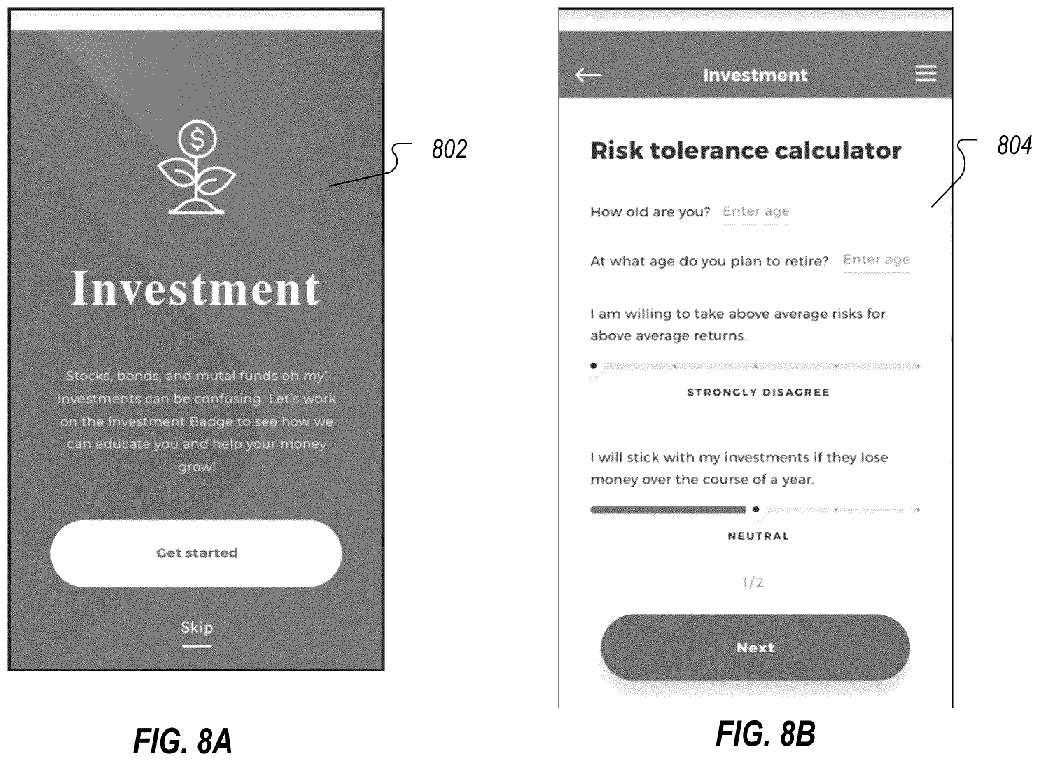

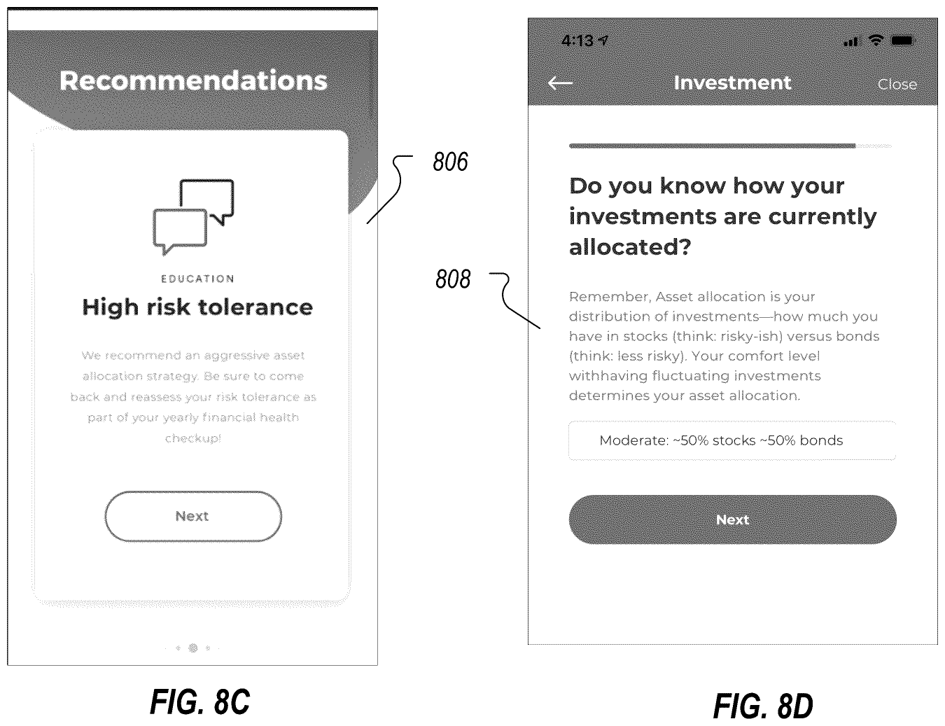

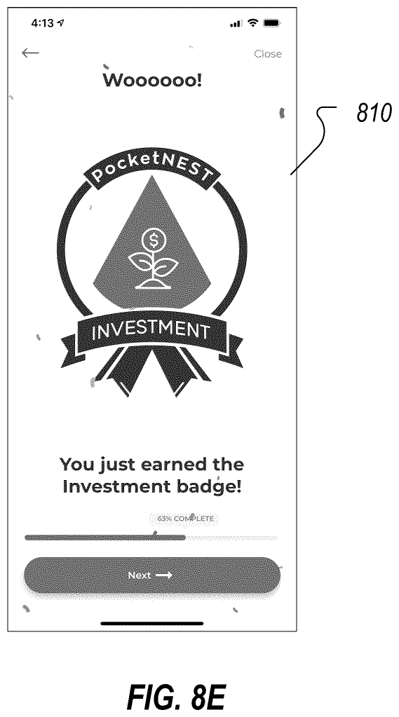

FIGS. 8A-8E illustrate various investment related screens. The investment screens may allow the user to input information about the user's current investments. The server 110 and/or service provider 102 may also provide recommendations based on this investment information, such as diversification, tax considerations, etc. The service provider 102 may connect the user with a third party tax specialist or investment firm.

FIG. 8A illustrates an example investment welcome screen 802. FIG. 8B illustrates a risk tolerance screen 804 presenting the user with a series of questions relating to a user's risk tolerance for investing. These questions may also ask certain questions about retirement age, current age, etc. In response to these questions, the goal application 116 may present the user with a risk level screen 806. This screen 806 may present the user with, based on the response to the inquiries in FIG. 8B, the user's risk tolerance and a description of the same. Other inquiries for the user may be presented by additional screens, including whether the user currently works with a financial advisor and/or planner, how many years of experience the user has with investing in the stock market, whether the user understands the difference between stock positions, mutual funds, index funds, ETFs, etc.

FIG. 8D illustrates an example investment allocation screen 808 where the goal application 116 presents the user with at least on inquiry on his or her investment calculation. The user may select from a drop down box between super conservative, conservative, moderate, moderate plus, aggressive, and unknown. FIG. 8E illustrates an example investment badge completed screen 810.

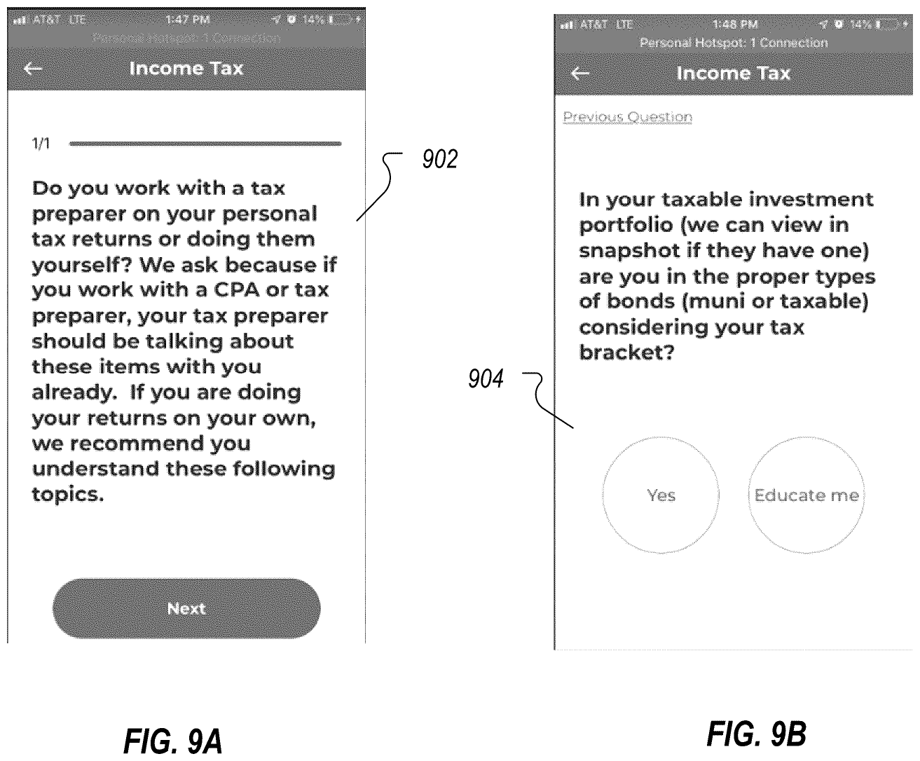

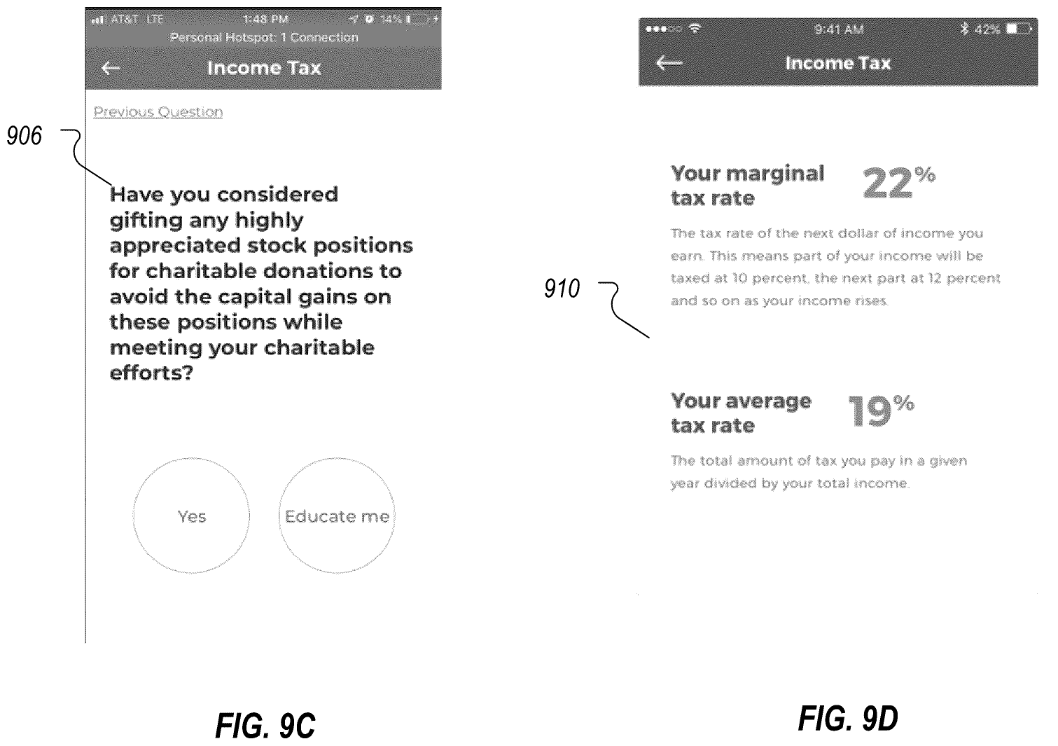

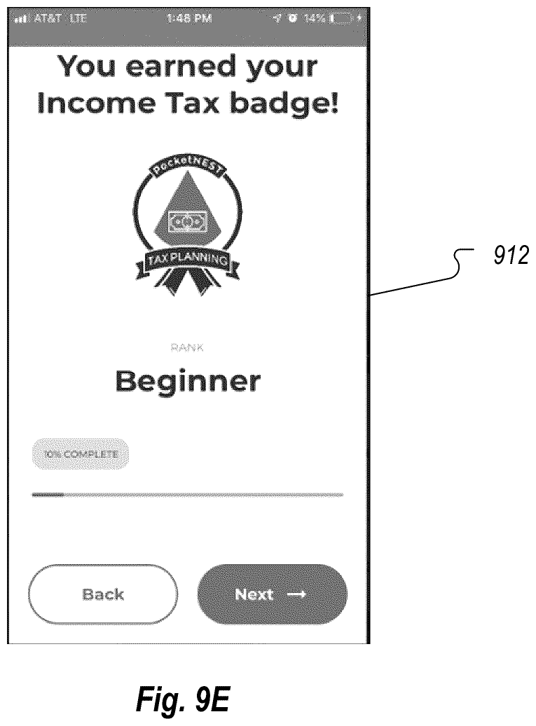

FIGS. 9A-9E illustrate various tax related screens. The tax screens may allow the user to input tax information. The server 110 may provide tax recommendations such as deductions, alternative minimum taxes, marginal tax rates, etc.

FIG. 9A illustrates an example income tax screen 902 including an inquiry into whether the user uses a professional to prepare his or her taxes. FIG. 9B illustrates an investment tax screen 904 inquiring as to whether the user is in the correct bonds considering his or her tax bracket. Similar to other screens, selecting “educate me” or “I do not know” buttons may prompt the goal application 116 to present an additional screen with further information relating to the inquiry to aid the user in his or her understanding of the question and/or various terminology.

FIG. 9C illustrates a gift tax screen 906. FIG. 9D illustrates an income tax bracket screen 910 indicating, based on the user provided answers to the questions in this badge, as well as other badges such as setup, the goal application 116 may present the user with a marginal tax rate, as well as an average tax rate. FIG. 9F illustrates an example tax badge completed screen 912.

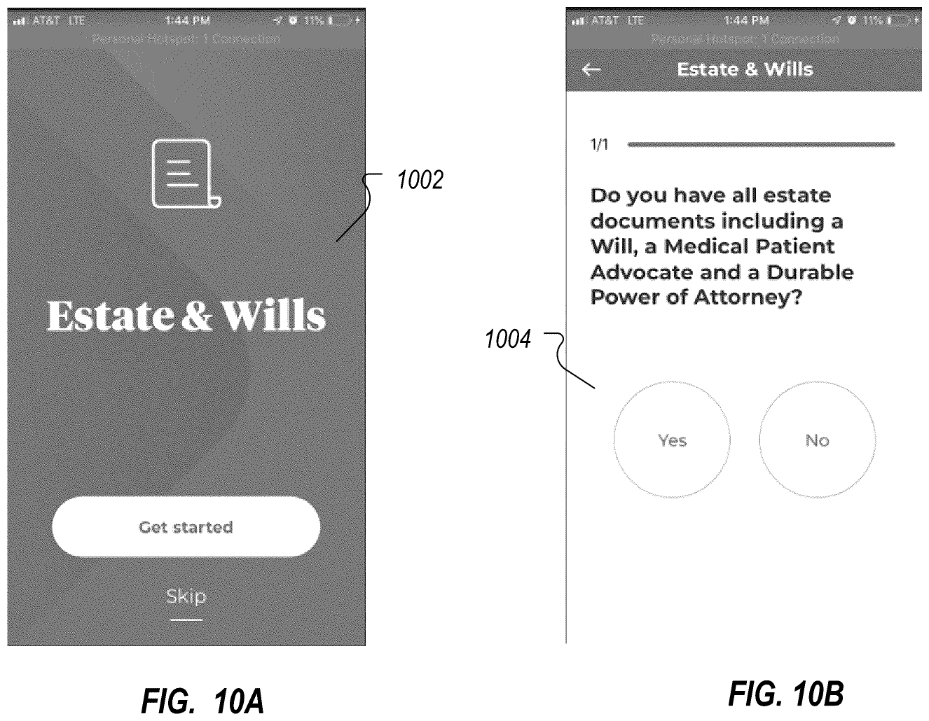

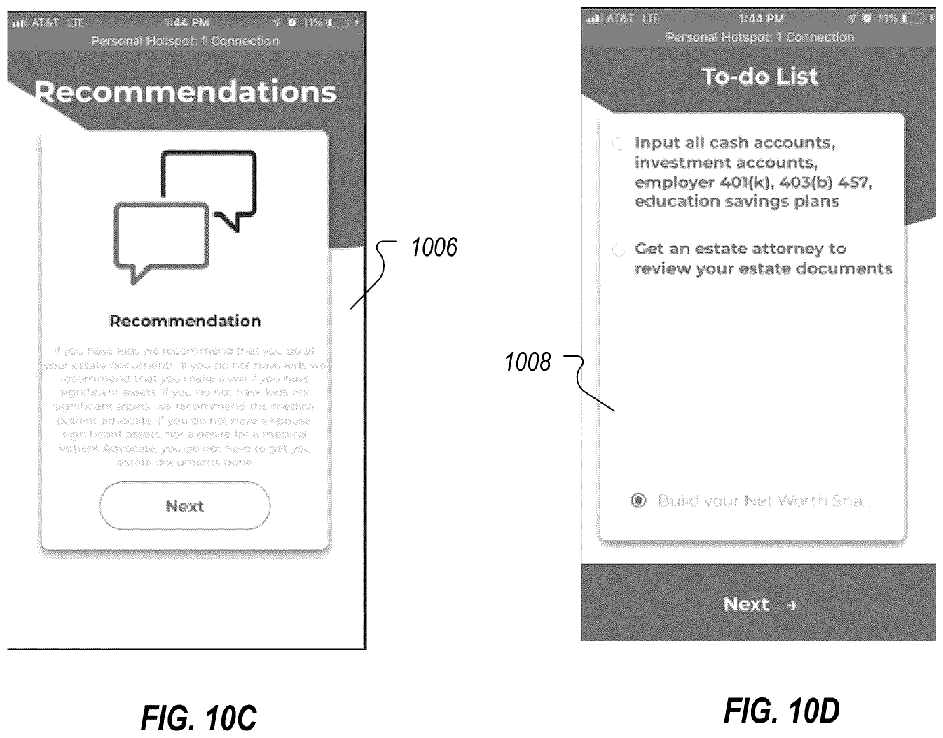

FIGS. 10A-10D illustrate various estate planning related screens. Similar to the previous areas of goal planning, the estate screens may allow a user to add information such as powers of attorney, medical advocate, etc. The server 110 and/or service provider 102 may provide information to the user in response to these, such as recommendations for an attorney, or various situation recommendation relating to young children of the user, life insurance policies, etc.

FIG. 10A illustrates an example estate start screen 1002. FIG. 10B illustrates an example estate inquiry screen 1004 inquiring into whether the user has certain documents prepared such as a will, medical and legal powers of attorney, etc. Based on the answers to these questions, which may be presented over various screens, various recommendations and to-do items may be presented to the user. FIG. 10C illustrates an example recommendation screen 1006 and FIG. 10D illustrates an example to-do screen 1008.

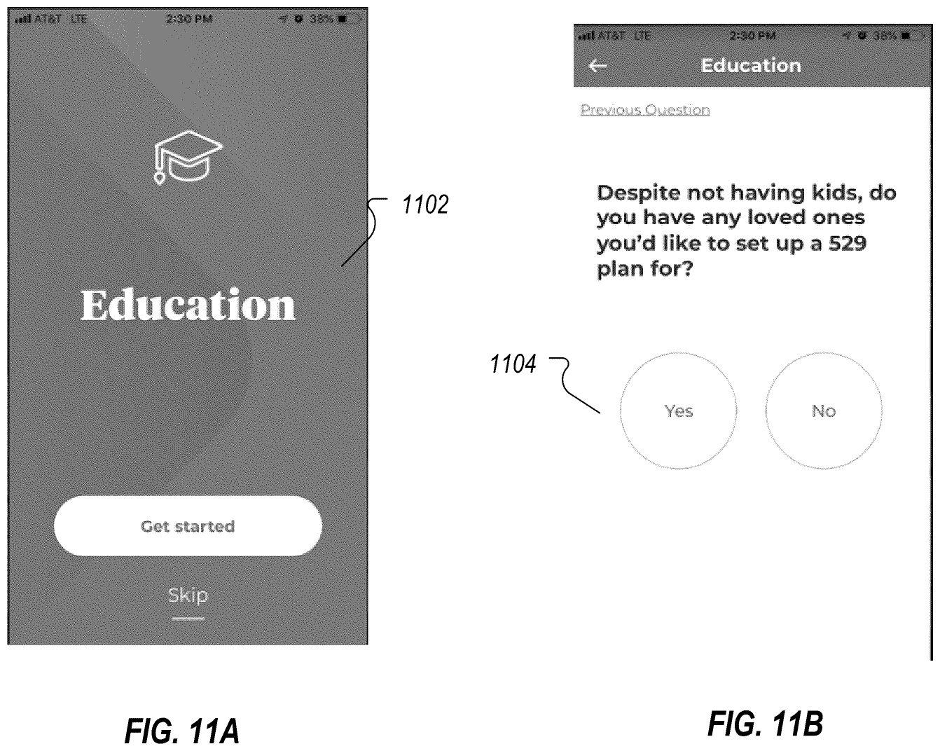

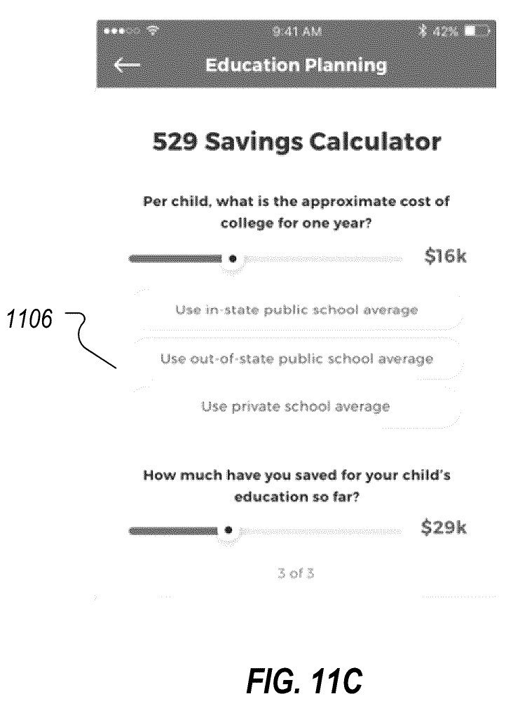

FIGS. 11A-11C illustrate various education related screens. The education screens may provide questions to the user such as the desired amount to be saved, tax related questions, etc. The server 110 may aggregate the data acquired from the education related screens, as well as other screens, and provide a recommended 592 plan to the user based on a holistic analysis of the user's financial and personal information. In one example, a 529 from the user's home state may be recommended. In another situation, based on tax considerations and the user's goals (e.g., to have a child attend a private institution instead of a public in-state institution), the server 110 and/or service provider 102 may recommend another state's plan.

FIG. 11A illustrates an example education start screen 1102. FIG. 11B illustrates an example ‘no kid’ education screen 1104 where the goal application 116 inquires as to whether there are other loved ones in which a 529 plan could be implemented. FIG. 11C illustrates a savings calculator screen 1106.

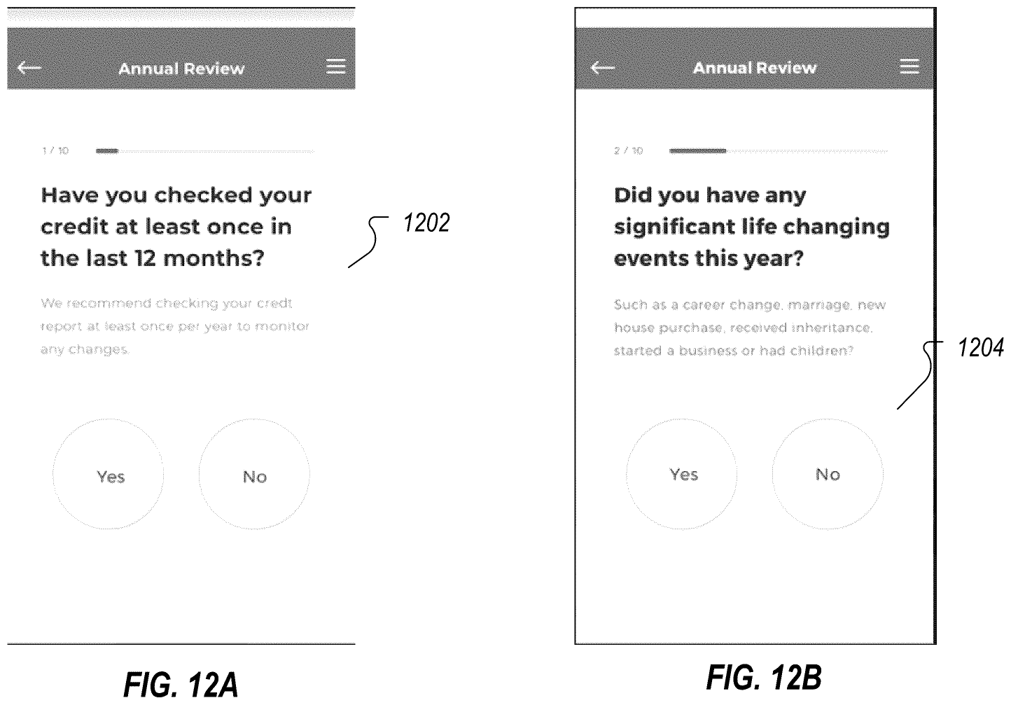

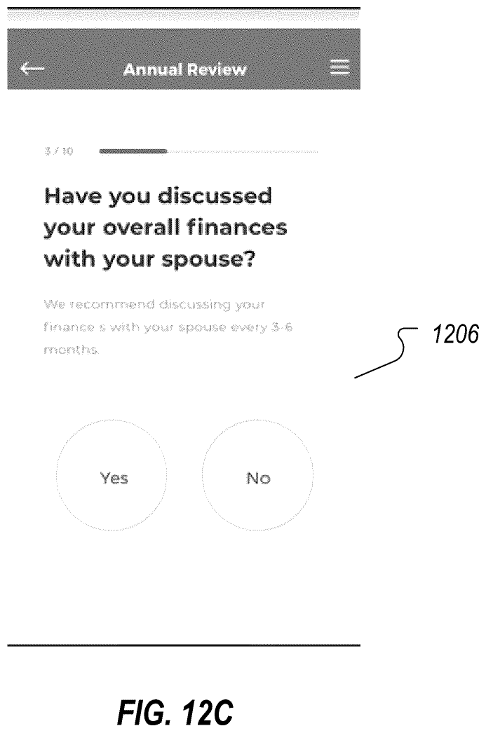

FIGS. 12A-12C illustrate various screens related to an annual review or the overall goal plan review. These screens may ask the user to input various life changes such as having children, buying a house, etc. Further, these screens may overlap with the snapshot screens indicating a net worth, net savings, etc.

FIG. 12A illustrates an example annual credit review screen 1202. FIG. 12B illustrates an example life change screen 1204. FIG. 12C illustrates an example spouse inquiry screen 1206.

FIGS. 13A-D illustrate example user interface screens provided by the service provider application 126. This application, as explained above, may provide user friendly and customizable screens to the service provider 102. These screens facilitate easy understanding of the service provider's users, both in aggregate, as well as on an individual basis. The provided screens in FIGS. 13A-D are exemplary and intended to illustrate examples of the service provider application's capabilities in response to the user entered data at the goal application 116, as well as data from linked accounts. By facilitating a robust, but filterable and configurable interface for the service provider 102, the service prover 102 is more efficiently, quickly, and accurately, able to identify needs, possible wants, and other goal related issues related to the users 104. The ability to aggregate the user information in one application, without the need to search, pull, or locate other data sources from other locations, other parties, etc., allows for the service provider application 126 to provide unprecedented abilities to the service provider 102 to increase service levels to its customers, decrease necessary man power, decrease data storage across multiple other systems, and increase possible sales, commissions, and efficiencies across the board.

FIG. 13A illustrates an example admin interface 1302 provided by the service provider application 126 at the computing device 120. The admin interface 1302 may include an expandable menu including a plurality of attributes 1306. Each attribute may correspond to data centered by the user via the goal application 116. Each attribute 1306 may be expanded by selecting the attribute or an icon (e.g., a “+” symbol) associated with the attribute 1306 to present sub-attributes that further define the selected attribute 1306. For example, the debt attribute may expand to show debt owned by a selected user, such as vehicle debt, student loan debt, mortgages, etc. The admin interface 1302 may also provide a list of users 1308 and associated user information, such as a “User since” date and “Last login” date.

A user summary button 1310 may be associated with each listed user 1308. Selection of one of these buttons may present a more detailed view of that user's data and profile.

FIG. 13B illustrates the example admin user interface 1302 similar to FIG. 13A, but with a filter panel 1320. The filter panel 1320 may present the service provider 102 with a plurality of filters configured to be applied to a group of users 1308. The filters may correspond to the attributes 1306 and allow for the attributes be used as filter requirements, such as income, state of residence, number or dependences, homeownership status, debt ratio, investment style, to name a few. Upon selecting and entering certain fillable and selectable filter options, the list of users 1308 may be repopulated with users that meet the entered criteria. Such a feature allows a service provider 102 to easily and efficiently acquire a list of users falling within certain criteria. This also allows the service provider to create groups of users who may be similar situated. Existing methods for doing this type of identification of users includes sifting through numerous databases across multiple platforms. Because the users have been guided through these inquiries via the goal application 116 to enter this data, that data is centralized, more accurate, more up to date, and now readily available for the service provider to use.

FIG. 13C illustrates an example user profile interface 1312. The user profile interface 1312 may present data or information about a selected user. This may be presented in response to selecting the user summary button 1310 (as shown in FIG. 13A) for a specific user. In some ways, this information may mirror the information entered by the user both in substance and in form. Similar drop-down menus are available for further information and may mirror the various badges presented and earned at the goal application 116, such as debt, insurance, estate planning, taxes, etc.

FIG. 13D illustrates and example user report 1330. The user report may be generated and available via either or both of the goal application 116 and the service provider application 126. The user report may be a succinct summary of a user's goal information, including a financial snapshot, to-do list, biographical data, etc. When presented via the goal application 116, the user may be able to see his or her to-dos, net worth, and tax brackets all in one place. Similarly, a service provider 102 may review the same type of easy to read, quickly generated form.

FIG. 14 illustrates an example process 1400 for the service provider application 126. As explained above, this may be done on a controller at the computing device 120 of a service provider 102, or at the server 110. In some examples, this process 1400 may even be carried out on the user device 106. The process 1400 starts at block 1405 where the controller receives user inputted data. As explained, this data may be inputted by the user at the user device 106 via a series of iterative and organized screens configured to guide the user through the process of goal setting. This data may include information on debt, income, insurance, estate planning, college savings, etc.

At block 1410, the controller may present an admin screen to the service provider 102. The admin screen may include examples as those shown in FIGS. 13A-C. The admin interface 1302 may present the plurality of selectable attributes 1306 that are filterable and customizable by the service provider 102. The user inputted data is associated with the attributes 1306.

At block 1415, the controller may receive selections of the attributes 1306. These selections may include selecting certain filters, as shown in FIG. 13B. These filters may be used to tailor or identify specific users for a certain service. For example, a life insurance filter may be applied to filter out users who do not currently have life insurance, or do not have enough life insurance. These users may then be possibly matched with life insurance services. In another example, the filter may apply a dependent or child status to filter out all users with minor children that may have an interest in new or different 529 education plans.

At block 1420, the controller may update the list of users 1308 to include those users meeting the filtered attributes assigned at block 1415. As explained above, further information on these users may then be reviewed and analyzed. The process 1400 may then end.

FIG. 15 illustrates an example process 1500 for the goal application 116. As explained above, this may be done on a controller at the user device 106 associated with a user 104. The process 1500 starts at block 1505 where the application 116 presents at least one screen associated with a goal, such as a tax, budget, estate goal, etc.

At block 1510, the controller may receive user inputted data. As explained, this data may be inputted by the user at the user device 106 via the series of iterative and organized screens configured to guide the user through the process of goal setting. Each screen may present an inquiry, or information that the user is to review.

At block 1515, the controller may determine if the goal is completed, or if any further screens or inquiries are to be completed with respect to the specific goal. When the user responds to the specific inquiries, subsequent screens may be presented based on the user's input until all of the questions have been answered or completed. If the goal is completed and no further questions exist, the process 1500 proceeds to block 1520. If not, the process proceeds back to block 1505 until all of the questions and items have been completed.

At block 1520, the controller may present or update the goal screen. This may include updating a specific badge associate with that goal to show as completed. This may also include updating a to-list screen to add or remove certain to-do items. Further, this may include updating a percentage of overall completions, a status or progress indicator for a specific goal, etc. The process 1500 may be achieved for each of the goals shown in FIG. 2. The process 1500 may then end.

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A goal management system, comprising:
a memory configured to maintain a database of user inputted goal data, the goal data being acquired from users of a goal planning application, the goal planning application configured to provide inquiries to be responded to by the users in furtherance of goals of the users; and
a controller configured to
receive the user inputted goal data,
present at least one admin screen including a plurality of selectable attributes and at least one user in a list of users associated with the user inputted goal data, wherein at least one of the selectable attributes is associated with at least a portion of the user inputted goal data and corresponds to at least one service provided by a third party service provider,
receive selection of the at least one of the attributes, and
update the list of users based on the selected at least one attribute to include users identified as requiring the at least one service provided by the third party service provider.
